(19) United States
(12) Patent Application Publication
(10) Pub. No.: US 2010/0260912 A1
(43) Pub. Date: Oct. 14, 2010

(54) RESVERATROL ENHANCED WINE

(76) Inventor: Philip Anthony Norrie, Elanora Heights (AU)

Correspondence Address: MORGAN, LEWIS & BOCKIUS LLP (SF), One Market, Spear Street Tower, Suite 2800, San Francisco, CA, 94105, US

(21) Appl. No.: 12/740,681

(22) PCT Filed: Oct. 14, 2008
(86) PCT No.: PCT/AU2008/001514

§ 371 Date: Jun. 1, 2010

(30) Foreign Application Priority Data
Oct. 31, 2007 (AU) 2007101055

(51) Int. Cl. C12G 1/00

(52) U.S. Cl. 426/541

(57) ABSTRACT

A process for increasing content of resveratrol in wine comprising adding resveratrol obtained from Vitis vinifera grapes to an aliquot of bulk wine to form a resveratrol concentrate and adding the resveratrol concentrate to bulk wine to produce a resveratrol enhanced wine.

### CROSS REFERENCE TO RELATED APPLICATIONS

This application is a U.S. National Phase of PCT Application No. PCT/AU2008/001514 filed Oct. 14, 2008, which claims priority to Australian Application No. 2007101055 filed Oct. 31, 2007, which applications are incorporated herein by reference in their entirety for all purposes.

### TECHNICAL FIELD

The present invention relates to a process for obtaining resveratrol enhanced wine having improved health characteristics.

### BACKGROUND

Humans have been consuming wine for about 9,000 years, beer for about 6,000 years and spirits for about 3,000 years. Wine is probably the oldest medicine, having been used as such for over 5,000 years.

Wine should be regarded as a food. Historically it has been regarded as such and has been an integral part of the healthful Mediterranean diet for thousands of years. Wine also has important religious connections, being used to represent the blood of Christ in holy communion.

Wine has been described as “a chemical symphony composed of ethylalcohol, several other alcohols, sugar, other carbohydrates, polyphenols, aldehydates, ketones and pigments, with half a dozen vitamins, fifteen to twenty minerals more than twenty-two organic acids and other things that have not yet been identified” (McDonald, J., Nutrition, A Symposium on Wine, Health and Society Wine Institute, Washington, D.C. Feb. 24, 1986)

“The centuries-old belief that wine used with meals is an aid to nutrition has been confirmed by research project at the University of California in Berkeley. In the first such study ever made a litre of Zinfandel wine or a litre of an equivalent (11.5 percent) aqueous solution of ethanol were fed daily with a controlled isocaloric diet to six healthy young adult males while their faeces, urine, and sweat were collected and analyzed. The results showed that all of the subjects had absorbed from their diet significantly more of such nutrients as calcium, phosphorus, magnesium, iron and zinc after taking the wine than after taking the alcohol solution. Equally significant was that when dealcoholized wine and deionized water were substituted for the wine and for the alcohol solution during part of the 75-day study, the results were similar. Significantly greater absorption of nutrients was found after the dealcoholized wine than after the water (Wine in Nutrition Study, Bulletin of the Society of Medical Friends of Wine, Vol. 17 No 1, February 1975).

Wine should also be regarded as separate from other alcohol containing beverages because wine is unique in that it is the only alcoholic beverage to not only contain alcohol but also nature's most potent antioxidants namely resveratrol (trans-3,5,4′-trihydroxystilbene), quercitin and epicatechin. Wine has the best mode of consumption because it is usually sipped slowly over a long period of time accompanying a meal, whereas beer and spirits do not contain these potent antioxidants and are usually consumed on an empty stomach thus greatly increasing their alcohol's absorption rate.

The main components that give wine its health benefits are alcohol and the polyphenol antioxidants. Alcohol is responsible for reduced clot formation (by increased fibrinolysis, reduced fibrinogen and reduced platelet aggregation), raised good cholesterol (high density lipoprotein (HDL)) levels and reduced bad cholesterol Low-density lipoprotein (LDL) levels—all of which help reduce vascular disease. The antioxidants are responsible for the rest of the health benefits of wine.

The antioxidants (polyphenols) which are only in wine are five times more potent than the standard benchmark antioxidants, Vitamin C and Vitamin E, plateau at 100% antioxidant activity after a few glasses. These antioxidants reduce insulin resistance and thus help to significantly reduce diabetes, block damage being done to DNA in cell nuclei reducing risk of cancer and increase the activity of mitogen activated protein (MAP) kinase to help reduce dementia by up to 80% (Orgogozo et al Wine Consumption and Dementia in the Elderly: A Prospective community study in the Bordeaux area, Revue Neurologique, Vol. 153 No. 2, 1997).

Antioxidants, especially resveratrol in wine, activate a nerve enzyme called MAP kinase which stimulates nerve cells and helps them regenerate their dendrites or nerve interconnections.

Free Radicals are poisonous waste products from metabolism which cause biological havoc to bodies. The antioxidants from wine neutralize the effect of these Free Radicals, thus protecting bodies from degeneration and aging i.e. cyto-protection or preventing cell death.

Macular Degeneration causes blindness in 30% of all people over the age of 65. It cannot be treated once it is established, but it can be prevented and the only thing that is known to help prevent it is consuming wine in moderation, which reduces the Macular Degeneration rate by up to 34% (Obisesan et al ‘Moderate wine consumption is associated with decreased odds of developing age-related macular degeneration’ in National Health and Nutrition Examination Survey (1971-1975). Journal of the American Geriatrics Society 1998, 46(1), pp 1-7).

The greatest health benefit from consuming wine in moderation daily though comes from the up to 50% reduction in vascular disease. This is not only coronary heart disease but the whole vascular tree including the brain (strokes), aorta (aneurysms), veins (deep vein thrombosis (DVT)) and kidneys (50% of renal failure is due to vascular disease). Vascular disease is the biggest cause of death in our society accounting for about half of all deaths. Latest medical research is showing that vascular disease is a chronic inflammatory disease, like rheumatoid arthritis, involving the internal lining of the vessel wall called the endothelium. Thus the new focus of research now is emphasizing the anti inflammatory effect on the endothelium to prevent rupture of atherosclerotic plaque and subsequent clotting that results in the obstruction of the blood vessel and death of the tissue supplied by that vessel. The antioxidants in wine significantly reduce this inflammation and clotting, thus reducing vascular disease deaths by up to 50%. This is a whole new exciting area of benefit and role for wine's antioxidants, not only involving complementary antioxidant mechanisms but also new alternative biological mechanisms for wine's polyphenols.

Normally bad cholesterol (LDL) is oxidised and then incorporated into the vessel wall to form atherosclerotic plaque which eventually swells up, then ruptures. This rupture is closed off by clot, which is the final event that causes an occlusion of the vessel. The endothelial inflammation theory explains why one person can have a large stable plaque, full of scar tissue binding it together, for decades which does not rupture while another person can have a small but unstable or inflamed plaque, which does rupture at an early age.

The antioxidants which occur in wine prevent the oxidation of the LDL so it cannot be incorporated in the vessel wall, reduce the bad cholesterol, raise the good cholesterol (which helps reabsorb plaque), reduce the inflammation of the endothelium and act as anticoagulants. So it can be seen that the antioxidants, unique to wine, have at least five major ways in which they help prevent vascular disease.

There have been many attempts to raise the resveratrol level of wine in the past. Firstly, there was manipulating the vineyard by spraying it with water to fool the grapes into thinking a fungal infection was going to occur. This was expensive, needed access to a lot of water and caused a lot of botrytis fungal infection of grapes so this avenue was abandoned. Second, some researchers are using genetic manipulation to develop new varieties of Vitis vinifera grapes higher in resveratrol content, but this would require all vineyards having to be grafted over to these new varieties later—a most expensive undertaking. Third, researchers have found ways to manipulate the winemaking process to raise the resveratrol level by adding in different enzymes at fermentation time to release more resveratrol from the grape skin. Unfortunately, more tannins and pigments are also released which make the resultant wine darker and taste of tannins. The winemaking process can also be modified to change the fining and filtering processes so that less resveratrol in the wine is stripped out or removed during normal fining and filtering processes. If all the these techniques are used, at best the resveratrol level could be increased by 50% so the resveratrol content in a normal white wine would go from 1 mg/l to 1.5 mg/l and in a red wine from 6 mg/l to 9 mg/l.

There are a number of published methods from China relating to the addition of resveratrol to wine but none of these methods produce a product that can be sold legally as wine. Chinese herbs together with resveratrol have been used to make a wine-derived product. Furthermore, alcohol has been used to dissolve resveratrol prior to adding to wine due to the poor solubility of resveratrol in water. Such a product is illegal for wine because the alcohol in wine can only come from the fermentation of grapes or additional grape concentrate.

Although wine has inherent beneficial components and characteristics, the wine industry is strictly controlled to prevent the addition of exogenous additives or components to wine. Thus, it has not been possible to enhance many beneficial characteristics of wine and still be able to market a legitimate and approved wine.

The present inventor has now developed a process for increasing the level of resveratrol in wine while still meeting regulatory and accepted wine industry standards for a wine.

### SUMMARY OF INVENTION

In a first aspect, the present invention provides a process for increasing content of resveratrol in wine comprising:
(a) adding resveratrol obtained from Vitis vinifera grapes to an aliquot of bulk wine to form a resveratrol concentrate; and
(b) adding the resveratrol concentrate to bulk wine to produce a resveratrol enhanced wine.

The resveratrol concentrate can be formed by adding at least about 0.1% (wt/vol) of resveratrol to the wine aliquot and distributing the resveratrol in the wine aliquot. Preferably from about 0.5 to 5% (wt/vol), more preferably about 1 to 2% (wt/vol) resveratrol is added to the wine aliquot.

The resveratrol concentrate can be formed by gentle heating of the wine aliquot and resveratrol. Preferably, the gentle heating is up to about 40° C. Preferably, the heating is provided or maintained at a level which does not adversely affect the normal characteristics of the wine.

Preferably, the wine aliquot is obtained from the same bulk wine to which the resveratrol concentrate will be added.

Preferably, the resveratrol enhanced wine has a resveratrol concentration of at least about 5 mg/l for white wine and at least about 10 mg/l for red wine.

The resveratrol concentration is typically enhanced by at least two times of the normal concentration in untreated wine. The enhancement can be significantly more such as about 5 times, 10 times, 15 times, or 20 times the normal concentration in untreated wine.

Preferably, the resveratrol enhanced wine has a resveratrol concentration of at least about 30 mg/l, at least about 40 mg/l, at least about 50 mg/l, at least about 60 mg/l, at least about 70 mg/l, at least about 80 mg/l, at least about 90 mg/l, at least about 100 mg/l, at least about 110 mg/l, at least about 120 mg/l, at least about 130 mg/l, at least about 140 mg/l, at least about 150 mg/l, at least about 160 mg/l, at least about 170 mg/l, at least about 180 mg/l, at least about 190 mg/l, or at least about 200 mg/l.

In a preferred form, the wine has a resveratrol concentration of about 50 mg/l.

In a preferred form, the wine has a resveratrol concentration of about 75 mg/l.

In a preferred form, the wine has a resveratrol concentration of about 100 mg/l.

In a preferred form, the wine has a resveratrol concentration of about 150 mg/l.

In a preferred form, the wine has a resveratrol concentration of about 200 mg/l.

In a second aspect, the present invention relates to a resveratrol enhanced wine produced by the method according to the first aspect of the present invention.

In a third aspect, the present invention relates to a resveratrol enhanced wine comprising at least 5 mg/l resveratrol for white wine and at least 10 mg/l resveratrol for red wine wherein the resveratrol is derived from Vitis vinifera grapes, and wherein substantially no alcohol or non-grape derived nutritional material has been added to the wine.

Preferably, the resveratrol enhanced wine has a resveratrol concentration of at least 20 mg/l. More preferably, the wine has a resveratrol concentration of at least 50 mg/l. In one preferred form, the wine has a resveratrol concentration of up to about 100 mg/l.

Preferably, the resveratrol enhanced wine has a resveratrol concentration of at least about 30 mg/l, at least about 40 mg/l, at least about 50 mg/l, at least about 60 mg/l, at least about 70 mg/l, at least about 80 mg/l, at least about 90 mg/l, at least about 100 mg/l, at least about 110 mg/l, at least about 120 mg/l, at least about 130 mg/l, at least about 140 mg/l, at least about 150 mg/l, at least about 160 mg/l, at least about 170 mg/l, at least about 180 mg/l, at least about 190 mg/l, or at least about 200 mg/l.

In a preferred form, the wine has a resveratrol concentration of about 50 mg/l.

In a preferred form, the wine has a resveratrol concentration of about 75 mg/l.

In a preferred form, the wine has a resveratrol concentration of about 100 mg/l.

In a preferred form, the wine has a resveratrol concentration of about 150 mg/l.

In a preferred form, the wine has a resveratrol concentration of about 200 mg/l.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed in Australia before the priority date of each claim of this specification.

In order that the present invention may be more clearly understood, preferred embodiments will be described with reference to the following drawing and examples.

### BRIEF DESCRIPTION OF THE DRAWING

FIG. 1 shows schematic of manufacturing process for resveratrol from Vitis vinifera grapes.

### MODE(S) FOR CARRYING OUT THE INVENTION

The health benefits of wine are due mainly to its alcohol content, salicylate content and antioxidant content. So to make wine healthier, the level of these three components in wine could be raised. Raising the alcohol content markedly is not desirable because of the risk of alcohol abuse. Furthermore, if the alcohol content becomes too high the resultant beverage becomes a fortified wine (port, muscat, tokay, brandy etc). Raising the level of salicylic acid is not desirable either as it would make the wine bitter. An option is to raise the antioxidant content in wine. Resveratrol is the main antioxidant in wine and is derived principally from the grape skin where it protects the grape from harm caused by fungal infection.

The present inventor has found that it is possible to add resveratrol into the bulk wine, usually after fining and filtering, preferably just before bottling.

In the present invention, resveratrol concentrate from 100% Vitis vinifera grapes is added to the wine, preferably after fining and filtering, and prior to bottling. Resveratrol is dissolved in wine following gentle heating, typically up to about 45° C., to form a resveratrol concentrate which then can be added to bulk wine to produce resveratrol enhanced wine which meets the legal requirements for wine.

The resultant enhanced resveratrol wine is much cheaper to manufacture and the process can be carried out at anytime of the year, instead of being restricted to vintage time when the fermentation process occurs.

Wine produced by the process according to the present invention has been approved by the Australian Wine and Brandy Corporation and the New South Wales Food Authority, where it complies with the Australian Food Standard for Wine.

### Resveratrol

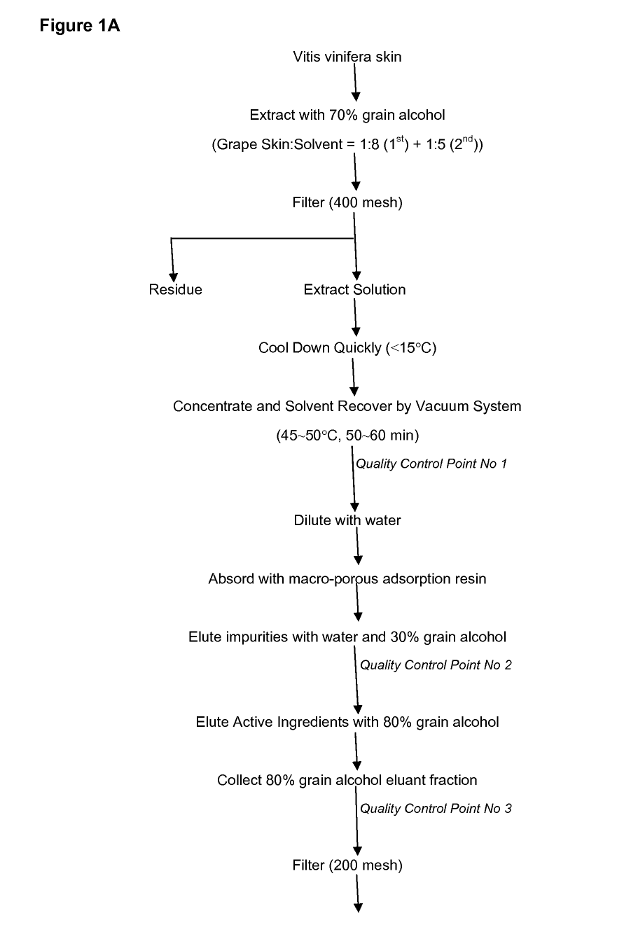

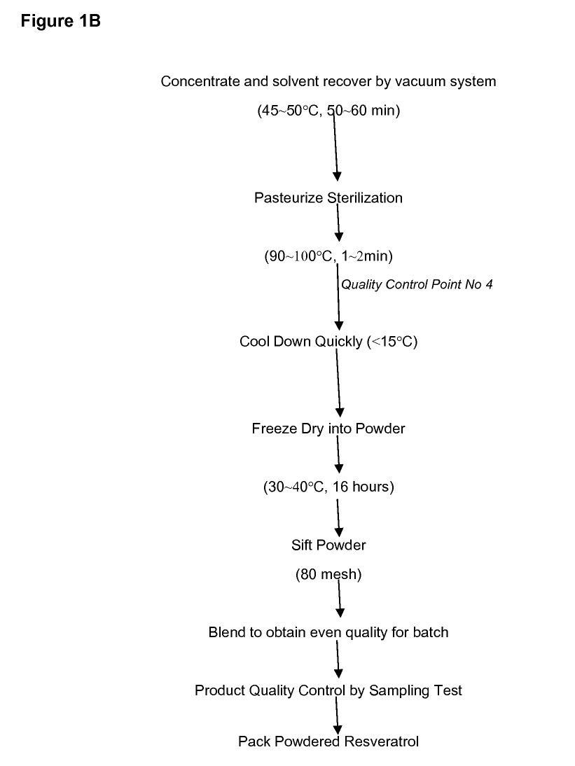

A preferred process for obtaining resveratrol from Vitis vinifera grapes is shown in FIG. 1.

Resveratrol maybe extracted from 100% Vitis vinifera grapes in such a way as to be tasteless, odourless and will dissolve fully into bulk wine so as to be colourless in wine.

It will be appreciated that the process depicted in FIG. 1 is one suitable means for extracting resveratrol from grapes. Other resveratrol extracting processes would also be suitable. Importantly, only resveratrol obtained from Vitis vinifera grapes can be used in the present invention to produce a legal wine.

A preferred source of resveratrol for use in the present invention is made by Organic Herbal Inc in China.

### Resveratrol Concentrate

Resveratrol concentrate is made by adding resveratrol extracted from 100% Vitis vinifera grapes to an aliquot of bulk wine without using additional alcohol or other non-wine solvents to dissolve the resveratrol.

The size, temperature and heating time for a batch of resveratrol concentrate will vary depending on how much resveratrol is needed to be added. For example, to dissolve 0.5 kg of resveratrol requires a batch of 40 litres of wine with heating to about 40° C. for a few minutes. Temperature can be measured by placing a thermometer in the batch of wine and timing the process.

It has been found that about 1.25% (wt/vol) resveratrol can be distributed in an aliquot of wine with heating up to about 40° C.

For convenience, between 10 l and 100 l of wine is used to prepare the resveratrol concentrate.

Smaller quantities of resveratrol dissolved in a larger volume wine aliquot may not require heating but may take more time to dissolve with gentle stirring.

A small batch or aliquot of the wine to be enhanced is used to prepare the resveratrol concentrate. The resveratrol concentrate is added to the batch and can be dissolved in the natural alcohol content of the wine. This process can be aided by gently heating the batch.

In order to ensure that there is no undue oxidation or degradation of the wine, it is preferred that the wine concentrate is prepared fresh and used within a day. Preferably, the resveratrol concentrate is prepared and used within a few hours.

### Resveratrol Enhancement

Resveratrol concentrate is added to the bulk wine to be enhanced, preferably after fining and filtering and just before bottling. The filter in the bottling line should not be so fine as to filter out the added resveratrol.

Once the resveratrol is fully dissolved in the batch, this resveratrol concentrate is then blended back into the vat of bulk wine from whence it came. Typically, 1 kg of resveratrol is added to 10,000 litres of bulk wine giving a resveratrol concentration of 100 mg/l. This concentration is therapeutic given that the normal recommended daily dose for resveratrol is 50 mg per human adult per day. The final concentration of resveratrol in the wine may vary depending on what is required. Higher concentrations of resveratrol require larger volumes of resveratrol concentrate and longer heating times.

A toxic dose of resveratrol has not been found and experimental mice have been fed up to 400 mg/kg with no ill effect. If a normal adult drank a full 750 ml bottle of resveratrol enhanced wine they would be consuming the resveratrol at a concentration of 1 mg/kg i.e. 400 times less than what has been found safe in mice. So toxicity should not be an issue with the present invention.

The resultant resveratrol enhanced wine does not taste any different from the wine stock from which it has been made. The resultant wine has no different colour, taste or bouquet to the starting wine and remains as clear as the original wine.

### EXAMPLES

### General

A preferred process for making 10,000 l of resveratrol enhanced wine is outlined below.

To an aliquot of 80 l of wine taken from bulk wine, add by slow addition under heating to 40° C. 1 kg of resveratrol obtained from Vitis vinifera grapes to form a resveratrol concentrate. The resveratrol is mixed into the wine to form a resveratrol concentrate which can be slightly hazy.

Add the resveratrol concentrate to remaining bulk wine by blending. The wine can be ready for bottling in a day or so after the resveratrol is dispersed or dissolved in the wine. The wine becomes clear after about a day when the resveratrol becomes fully dissolved into the bulk wine, typically due to the exposure to the bulk wine's larger amount of alcohol.

The wine was tested for alcohol, sugar, volatile acidity and sulphur routinely and was found to be okay.

Other steps to bottling:
reds—racking off lees from one tank to another tank.
whites—wine passed through diatomacious earth filter to remove any un-dissolved particles and then passed through a 0.45 micron filter at the bottling line (both processes are not fine enough to remove any dissolved resveratrol).

### Wine

6,000 bottles of resveratrol enhanced chardonnay from McLaren Vale were made by adding 40 litres of resveratrol concentrate containing 0.5 kg of resveratrol to 5000 l bulk wine prior to bottling.

6,000 bottles of resveratrol enhanced shiraz from McLaren Vale were made by adding 40 litres of resveratrol concentrate containing 0.5 kg of resveratrol to 5000 l bulk wine prior to bottling.

2008 TWD chardonnay McLaren Vale was made by Andrei Dorach, winemaker at Boar's Rock winery in McLaren Vale. The 6,000 bottles were made by adding 500 g of resveratrol to 40 litres of wine and heating to 40 degrees celcius for a few minutes then adding this mixture to the rest of the 5,000 l of bulk wine. Resveratrol concentration was around 100 mg/l.

2006 TWD shiraz McLaren Vale was made by Andrei Dorach, winemaker at Boar's Rock winery in McLaren Vale. The 6,000 bottles were made by adding 500 g of resveratrol to 40 litres of wine and heating to 40 degrees celcius for a few minutes then adding this mixture to the rest of the 5,000 l of bulk wine. Resveratrol concentration was around 100 mg/l.

36 bottles of resveratrol enhanced chardonnay from Pendarves Estate in Hunter Valley were made—these wines are still clear and aging well after cellaring.

36 bottles of resveratrol enhanced shiraz from Pendarves Estate in Hunter Valley were made—these wines are still clear and aging well after cellaring.

2006 REW chardonnay trial, 2006 Pendarves chardonnay control, 2006 REW shiraz trial, 2006 Pendarves shiraz control were all made by Letitia “Trish” Cecchini, winemaker at Serenella winery in Hunter Valley. As this was the first resveratrol enhanced wine (REW) experiment only about 36 bottles of each were made “by hand” in her winery laboratory with gentle heating. The resultant resveratrol concentrations were 120 mg/l for the chardonnay and 155 mg/l for the shiraz.

### Tasting Notes

2008 TWD Un-wooded Chardonnay—McLaren Vale

Star bright & good colour, good nose with fruit, well balanced fruit with finish & length. No sign of precipitation or taint

### 2006 REW Chardonnay Trial

Star bright & good colour, solid chardonnay fruit, showing bottle age development, good fruit & length. No sign of precipitation or taint.

### 2006 Pendarves Chardonnay Control

Star bright & good colour, good ripe chardonnay with bottle age, great fruit finish.

### 2006 TWD Shiraz—McLaren Vale

Deep purple colour, quite intense, plummy shiraz length and finish. No sign of precipitation or taint.

### 2006 Pendarves Shiraz—Trial

Deep colour, showing bottle age, powerful fruit, lovely supple smoothness and length. No sign of precipitation or taint.

### 2006 Pendarves Shiraz—Control

Deep colour, showing bottle age, powerful fruit, as above, great shiraz.

### Benefits of Resveratrol Enhanced Wine

Some of the many potential benefits of resveratrol enhanced wine are listed below
I. Reduced vascular disease (which kills up to 50% of adults) resulting in:
   (a) Reduced Coronary Heart Disease by up to 50%
   (b) Reduced Ischaemic Stroke (Ischaemic strokes account for 90-95% of all strokes)
   (c) Reduced Deep Vein Thrombosis by up to 50%
   (d) Reduced Osteoporosis
   (e) Reduced dementia in the Elderly
   (f) Reduced Macular Degeneration (a common cause of blindness) by up to 34%)
   (g) Reduced Renal Failure (up to 50% of renal failure due to vascular disease)
II. Tonic—wine contains many substances including most vitamins, minerals, trace elements, proteins and carbohydrates
III. Fat and cholesterol free source of carbohydrate
IV. Reduced cancer because the antioxidants in wine block free radicals causing damage to the cell's nucleus
V. Reduced blood pressure
VI. Antiseptic due to alcohol and more importantly polyphenols
VII. Increases morale and appetite—nursing home and hospital patients
VIII. Wine contains quercetin, resveratrol and epicatechin, which are potent antioxidants and also act as anti-carcinogens
IX. Reduction in colds/upper respiratory tract infections (URTI) by up to 85%
X. Diabetes reduced by up to 50% because the antioxidants reduce insulin resistance. Dry wine best alcoholic drink that is allowed with diabetes as all the sugar has been converted to alcohol
XI. Reduced gallstones by up to 30%
XII. Reduced kidney stones by up to 39%
XIII. Reduced Alzheimer's disease and multi-infarct (stroke) forms of dementia by up to 80%
XIV. Reduced Parkinson's disease
XV. Improved digestion
XVI. Reduced H. Pylori infection of the stomach and duodenum leading to reduced ulcers
XVII. Improved physical and intellectual condition in the elderly
XVIII. Reduced Hepatitis A
XIX. Reduced stress and depression
XX. Reduced Essential Tremor
XXI. Reduced tooth decay
XXII. Reduced cancer of the prostate by up to 50%

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A process for increasing content of resveratrol in wine comprising:
adding resveratrol obtained from Vitis vinifera grapes to an aliquot of bulk wine to form a resveratrol concentrate; and
adding the resveratrol concentrate to bulk wine to produce a resveratrol enhanced wine.

2. The process according to claim 1 wherein the resveratrol concentrate is formed by adding at least 0.1% (wt/vol) of resveratrol to the wine aliquot and dissolving the resveratrol in the wine.

3. The process according to claim 2 wherein 0.5 to 5% (wt/vol) of resveratrol is added to the wine aliquot.

4. The process according to claim 3 wherein 1 to 2% (wt/vol) resveratrol is added to the wine aliquot.

5. The process according to any one of claims 1 to 4 wherein the resveratrol concentrate is formed by gentle heating of the wine aliquot and resveratrol.

6. The process according to claim 5 wherein the wine is heated up to about 40° C.

7. The process according to any one of claims 1 to 6 wherein the wine aliquot is obtained from the same bulk wine to which the resveratrol concentrate is added.

8. The process according to any one of claims 1 to 7 wherein the resveratrol enhanced wine has a resveratrol concentration of at least 5 mg/l for white wine and at least 20 mg/l for red wine.

9. The process according to claim 8 wherein the wine has a resveratrol concentration of from 20 to 200 mg/l.

10. The process according to claim 9 wherein the wine has a resveratrol concentration of about 100 mg/l.

11. The process according to claim 10 wherein the wine has a resveratrol concentration of about 150 mg/l.

12. A resveratrol enhanced wine produced by the process according to any one of claims 1 to 11.

13. A resveratrol enhanced wine comprising at least 10 mg/l resveratrol wherein the resveratrol is obtained from Vitis vinifera grapes, and wherein substantially no alcohol or non-grape derived nutritional material has been added to the wine.

14. The enhanced wine according to claim 13 having a resveratrol concentration of at least 20 mg/l.

15. The enhanced wine according to claim 14 having a resveratrol concentration of at least 50 mg/l.

16. The enhanced wine according to claim 15 having a resveratrol concentration of at least 100 mg/l.

17. The enhanced wine according to claim 16 having a resveratrol concentration of up to about 200 mg/l.
